(19) United States
(12) Patent Application Publication
(10) Pub. No.: US 2024/0137828 A1
(43) Pub. Date: Apr. 25, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/404,336

(22) Filed: Jan. 4, 2024

Related U.S. Application Data
(63) Continuation of application No. PCT/JP2022/026685, filed on Jul. 5, 2022.

(30) Foreign Application Priority Data
Jul. 8, 2021 (JP) 2021-114499

(51) Int. Cl. H04W 36/08; H04L 5/00; H04W 36/00

(52) U.S. Cl. CPC H04W 36/083; H04L 5/0053; H04W 36/0061

(57) ABSTRACT

The communication control method includes making, by a first communication node including a relay node under the first communication node, an inquiry about cell IDs available in the relay node to a second communication node. The communication control method includes, in response to the inquiry, by the second communication node, determining a cell ID not colliding with the cell ID available in the second communication node from among the cell IDs available in the relay node, and transmitting the determined cell ID to the first communication node. The communication control method includes transmitting, by the first communication node, the determined cell ID to the relay node. The communication control method includes executing, by the relay node, movement processing by using the determined cell ID.

### RELATED APPLICATIONS

The present application is a continuation based on PCT Application No. PCT/JP2022/026685, filed on Jul. 5, 2022, which claims the benefit of Japanese Patent Application No. 2021-114499 filed on Jul. 9, 2021. The content of which is incorporated by reference herein in their entirety.

### TECHNICAL FIELD

The present disclosure relates to a communication control method used in a cellular communication system.

### BACKGROUND OF INVENTION

In the Third Generation Partnership Project (3GPP), which is a project for the standardization of cellular communication systems, introducing a new relay node referred to as an Integrated Access and Backhaul (IAB) node (for example, see “3GPP TS 38.300 V16.5.0 (2021-03)”) is being considered. One or more relay nodes are involved in communication between a base station and a user equipment and perform relay for the communication.

### SUMMARY

In a first aspect, a communication control method is used in a cellular communication system. The communication control method includes making, by a first communication node including a relay node under the first communication node, an inquiry about cell Identities (IDs) available in the relay node to a second communication node. The communication control method includes, in response to the inquiry, by the second communication node, determining a cell ID not colliding with the cell ID available in the second communication node from among the cell IDs available in the relay node, and transmitting the determined cell ID to the first communication node. The communication control method includes transmitting, by the first communication node, the determined cell ID to the relay node. The communication control method includes executing, by the relay node, movement processing by using the determined cell ID.

In a second aspect, a communication control method is used in a cellular communication system. The communication control method includes detecting, by a relay node, a fact that a cell currently in use is to become unavailable. The communication control method includes transmitting, by the relay node, a cell ID of the cell to become unavailable to a child node of the relay node and/or a user equipment.

In a third aspect, a communication control method is used in a cellular communication system. The communication control method includes transmitting, by a source donor node, a request message for making a request about a conditional handover including time in a trigger condition (Time-triggered Conditional Handover (CHO)) to a target donor node. The communication control method includes transmitting, by the target donor node, in response to reception of the request message, an accept message for accepting the request to the source donor node. The communication control method includes configuring, by the source donor node, in response to reception of the accept message, a relay node to execute the conditional handover with a sufficiency of time.

In a fourth aspect, a communication control method is used in a cellular communication system. The communication control method includes broadcasting, by a relay node, a first cell ID indicating a cell ID currently in use and a second cell ID indicating a changed cell ID. The communication control method includes causing, by the relay node, a child node of the relay node accessing a cell of the first cell ID and/or a user equipment accessing the cell of the first cell ID to perform a handover to the cell of the second cell ID. The communication control method includes stopping, by the relay node, broadcasting the first cell ID after causing the child node and/or the user equipment to perform the handover.

In a fifth aspect, a communication control method is used in a cellular communication system. The communication control method includes determining, by a first communication node, based on Physical Random Access Channel (PRACH) configuration of a neighboring cell received from a neighboring node neighboring the first communication node, the PRACH configuration not colliding with the PRACH configuration of the neighboring cell. The communication control method includes transmitting, by the first communication node, the determined PRACH configuration to a relay node.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes according to an embodiment.

FIG. 3 is a diagram illustrating a configuration example of a gNB (donor node) according to an embodiment.

FIG. 4 is a diagram illustrating a configuration example of an IAB node (relay node) according to an embodiment.

FIG. 5 is a diagram illustrating a configuration example of a user equipment (UE) according to an embodiment.

FIG. 6 is a diagram illustrating an example of a protocol stack related to a Radio Resource Control (RRC) connection and a Non-Access Stratum (NAS) connection of an IAB-MT according to an embodiment.

FIG. 7 is a diagram illustrating an example of a protocol stack related to an F1-U protocol according to an embodiment.

FIG. 8 is a diagram illustrating an example of a protocol stack related to an F1-C protocol according to an embodiment.

FIG. 9A and FIG. 9B are diagrams illustrating examples of transmitting (a list of) cell IDs according to a first embodiment.

FIG. 10 is a diagram illustrating a specific example according to the first embodiment.

FIG. 11 is a diagram illustrating an operation example according to the first embodiment.

FIG. 12 is a diagram illustrating an operation example according to a first variation of the first embodiment.

FIG. 13 is a diagram illustrating an operation example according to a second variation of the first embodiment.

FIG. 14 is a diagram illustrating an operation example according to a third variation of the first embodiment.

FIG. 15A and FIG. 15B are diagrams illustrating examples of an F1 container according to the third variation of the first embodiment.

FIG. 16 is a diagram illustrating an operation example according to a second embodiment.

FIG. 17 is a diagram illustrating an operation example according to a third embodiment.

FIG. 18 is a diagram illustrating an operation example according to a fourth embodiment.

FIG. 19 is a diagram illustrating an example of collision between Physical Random Access Channel (PRACH) resources according to a fifth embodiment.

FIG. 20 is a diagram illustrating an operation example according to the fifth embodiment.

FIG. 21 is a diagram illustrating an operation example according to a first variation of the fifth embodiment.

FIG. 22 is a diagram illustrating an operation example according to a second variation of the fifth embodiment.

### DESCRIPTION OF EMBODIMENTS

A cellular communication system in an embodiment is described with reference to the drawings. In the description of the drawings, the same or similar parts are denoted by the same or similar reference signs.

Configuration of Cellular Communication System

First, a configuration example of the cellular communication system in an embodiment is described. In an embodiment, the cellular communication system is a 3GPP 5G system. Specifically, a radio access scheme in the cellular communication system is New Radio (NR) being a 5G radio access scheme. Note that Long Term Evolution (LTE) may be at least partially applied to the cellular communication system. A future cellular communication system such as 6G may be applied to the cellular communication system.

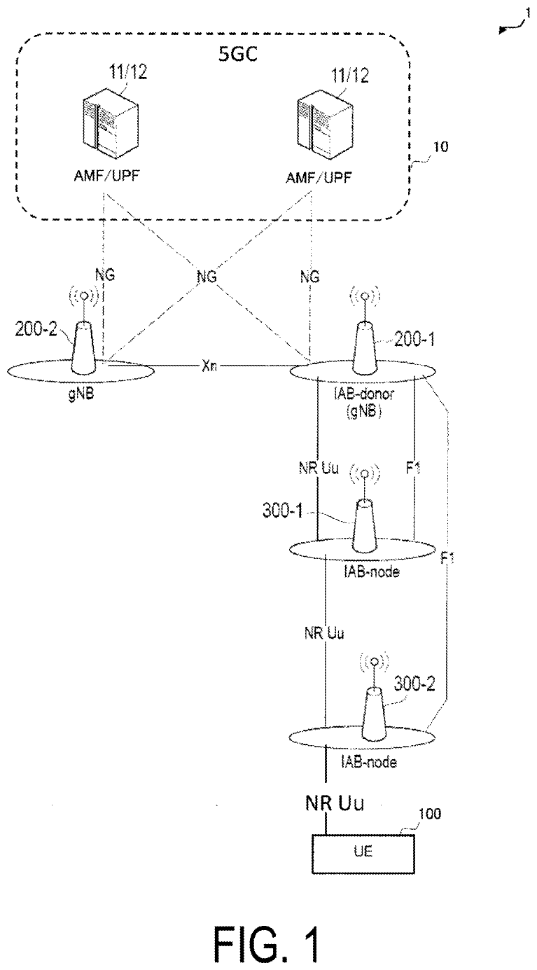

FIG. 1 is a diagram illustrating a configuration example of a cellular communication system 1 according to an embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a next generation Node B (gNB).

An example in which the base station 200 is an NR base station is mainly described below, but the base station 200 may also be an LTE base station (i.e., an evolved Node B (eNB)).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. A “cell” may be used without being distinguished from a base station such as the gNB 200. One cell belongs to one carrier frequency.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses New Radio (NR) for the backhaul to enable wireless relay of the NR access. The donor gNB (or a donor node, which may be hereinafter referred to as a “donor node”) 200-1 is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul links.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal or a tablet terminal, a laptop PC, a sensor or an apparatus that is provided in a sensor, a vehicle or an apparatus that is provided in a vehicle, and an unmanned aerial vehicle or an apparatus provided in an unmanned aerial vehicle. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1. FIG. 1 illustrates an example in which the IAB node 300-2 and the IAB node 300-1 function as relay nodes.

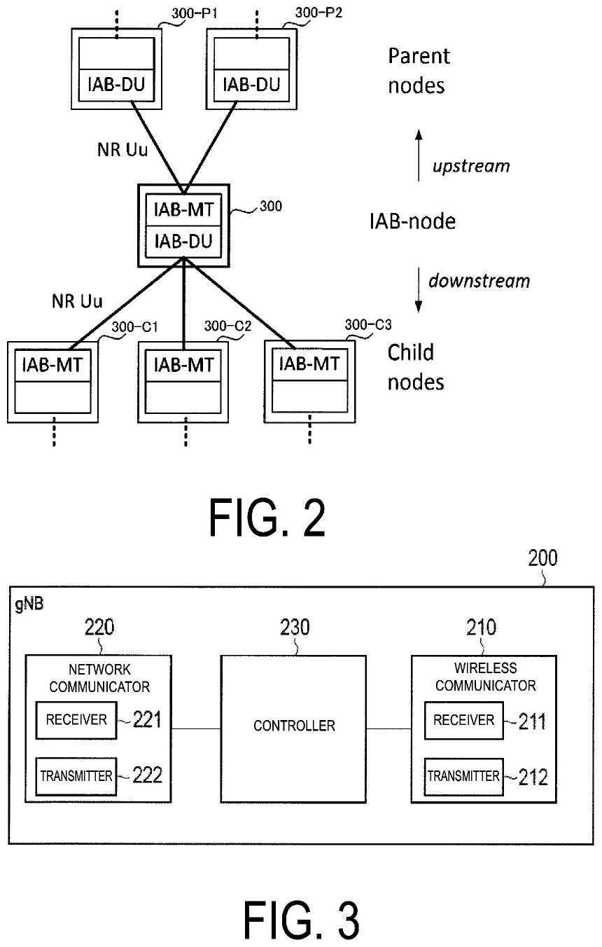

FIG. 2 is a diagram illustrating a relationship between the IAB node 300, Parent nodes, and Child nodes.

As illustrated in FIG. 2, each IAB node 300 includes an IAB-DU corresponding to a base station functional unit and an IAB-Mobile Termination (MT) corresponding to a user equipment functional unit.

Neighboring nodes of the IAB-MT (i.e., upper node) connected through an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) connected through an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes interfaced with the IAB-DU are child nodes, and the neighboring nodes interfaced with the IAB-MT are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

Configuration of Base Station

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then output to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The processor performs processing of the layers described below. The controller 230 may perform various types of processing in the gNB 200 (or the donor node 200) in each embodiment described below.

Configuration of Relay Node

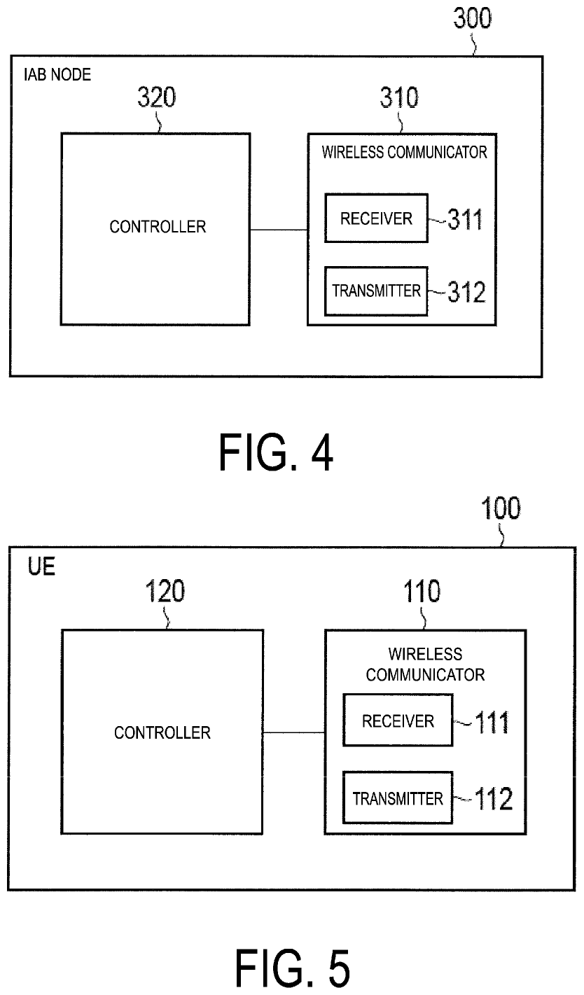

A configuration of the IAB node 300 that is a relay node (or a relay node apparatus, which may be hereinafter referred to as a “relay node”) in the embodiment is described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then output to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 320 may perform various types of processing in the IAB node 300 in each embodiment described below.

Configuration of User Equipment

A configuration of the UE 100 that is a user equipment according to the embodiment is described. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then output to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 120 may perform each processing in the UE 100 in each embodiment described below.

Configuration of Protocol Stack

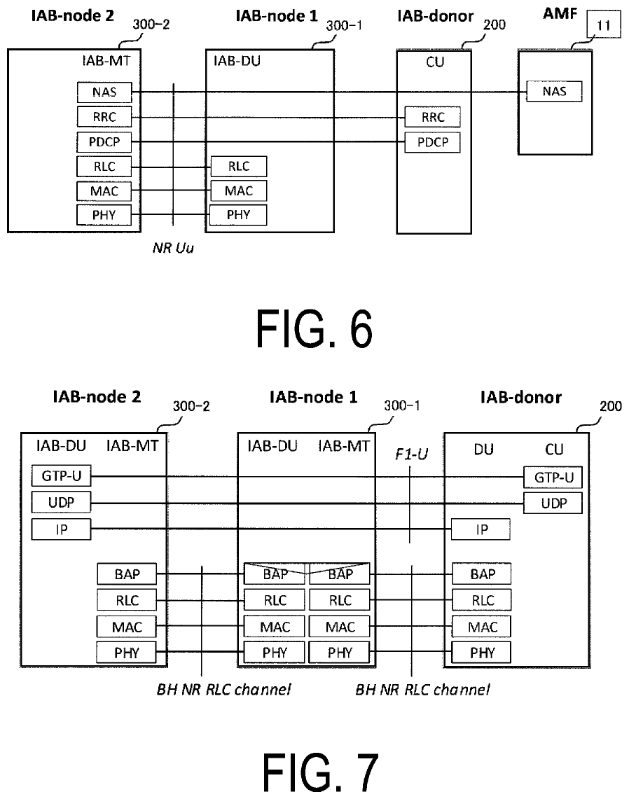

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (Hybrid Automatic Repeat reQuest (HARQ)), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines transport formats (transport block sizes, Modulation and Coding Schemes (MCSs)) in the uplink and the downlink and resource blocks to be allocated.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the CU of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the CU of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the NAS layer of the AMF 11.

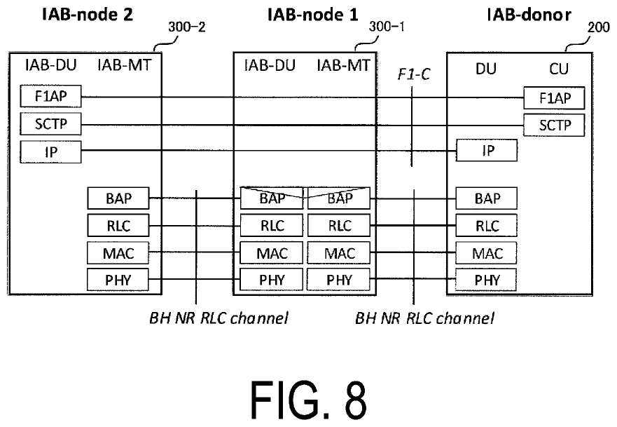

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as a higher layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring each BH link to include a plurality of backhaul RLC channels enables the prioritization and Quality of Service (QoS) control of traffic. The association between the BAP PDU and the backhaul RLC channel is executed by the BAP layer of each IAB node 300 and the BAP layer of the donor node 200.

Note that the CU of the donor node 200 is a gNB-CU function of the donor node 200 that terminates the F1 interface to the IAB node 300 and the DU of the donor node 200. The DU of the donor node 200 is a gNB-DU function of the donor node 200 that hosts an IAB BAP sublayer and provides a wireless backhaul to the IAB node 300.

As illustrated in FIG. 8, the protocol stack of the F1-C protocol includes an F1AP layer and an SCTP layer instead of a GTP—U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

PCI Collision

As an Identity (ID) for identifying a cell, an NR Cell Global ID (NCGI) is known. The NCGI is used for globally identifying an NR cell. The NCGI consists of a Public Land Mobile Network (PLMN) ID to which a cell belongs and an NR Cell Identity (NCI) of the cell. Because the NCGI includes the PLMN ID being an operator identification number and also includes the NCI, using the NCGI allows global and unique identification of a cell. Thus, collision of the NCGIs does not occur.

The NCI also consists of a gNB ID and a cell ID, and allows unique identification of a gNB in a PLMN. Thus, collision of the NCIs does not basically occur either.

On the other hand, in 5G, 1008 Physical Cell IDs (PCIs) are prepared, and these do not allow unique identification in a PLMN.

At present, in 3GPP, a Mobile IAB, which is an IAB node 300 that moves, has been under study. Regarding movement of the IAB node 300, movement may be performed in the donor node 200 that manages the IAB node 300, or movement may be performed to a donor node different from the donor node 200.

Due to such movement of the IAB node 300, the IAB node 300 may approach a different IAB node having the same PCI. Due to such approach, in respective cells under different IAB nodes, processing may be performed with use of the same PCI.

Thus, due to movement of the IAB node 300, PCI Collision may occur. Due to PCI Collision, the following malfunctions may occur.

That is, the UE 100 may select a non-optimal cell in cell search. In cell search, the UE 100 calculates the PCI, using a Primary Synchronization Signal (PSS) and a Secondary Synchronization Signal (SSS). Due to PCI Collision, the UE 100 performs such calculation that actually different cells have PCIs of one cell. Thus, the UE 100 may select a non-optimal cell. In the UE 100, reception itself of the PSS and the SSS may take time.

Due to PCI Collision, the UE 100 may fail in a handover. That is, when the source base station 200 performs handover processing based on the PCI included in a Measurement Report, the source base station 200 may cause the UE 100 to perform a handover to a cell different from a correct target cell.

The first embodiment has an object to reduce occurrence of PCI Collision due to movement of the IAB node 300.

Cell ID and PCI

The PCI and the cell ID are based on different concepts. As described above, in 5G, the PCI is an ID corresponding to one of 1008 PCIs prepared in advance. On the other hand, the cell ID is an ID associated with a subset of PLMNs, and is broadcast using System Information Block type 1 (SIB1).

Note that, in the following, the PCI and the cell ID may be used without being distinguished from each other, unless otherwise specifically noted. The PCI and the cell ID may be collectively referred to as a cell ID. These are the same and/or similar not only in the first embodiment but also in second and subsequent embodiments. Note that, when the PCI and the cell ID are distinguished, the cell ID may be referred to as a Cell ID.

Notification of Cell ID

The cell ID is configured with Operations, Administration, and Maintenance (OAM) for the gNB-DU.

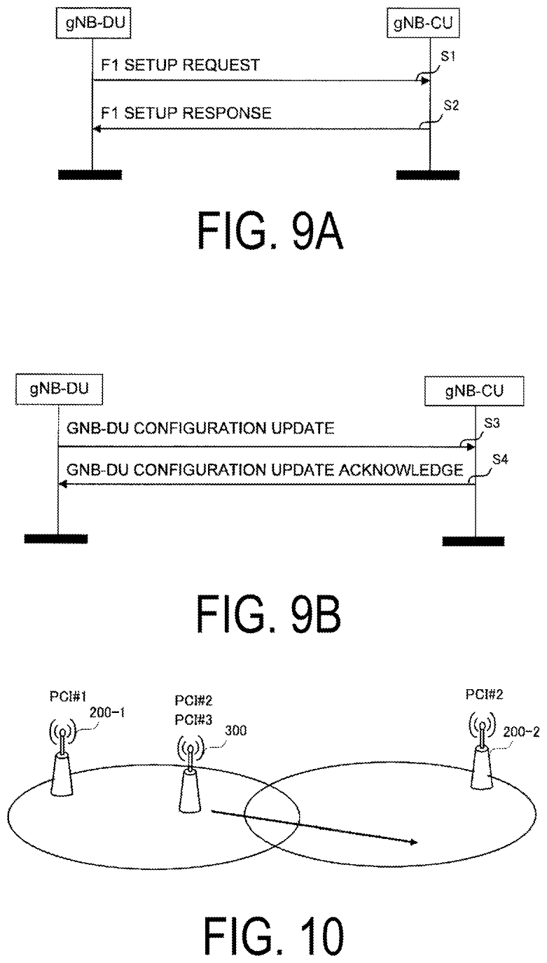

On the other hand, the gNB-DU can transmit (a list of) cell IDs to the gNB-CU. FIG. 9A is a diagram illustrating an example of transmitting (a list of) cell IDs according to the first embodiment. FIG. 9A illustrates an example of transmitting (a list of) cell IDs, using an F1 Setup Request message. Note that F1 Setup is used in exchange of application data necessary for accurate and mutual operation in an F1 interface between the gNB-DU and the gNB-CU. The F1 Setup Request message is a message for requesting such F1 Setup.

As illustrated in FIG. 9A, in Step S1, the gNB-DU transmits an F1 Setup Request message including (a list of) cell IDs of the cells to the gNB-CU. In Step S2, the gNB-CU transmits an F1 Setup Response message including (a list of) cell IDs to be activated to the gNB-DU.

FIG. 9B is a diagram illustrating an example of transmitting (a list of) cell IDs according to the first embodiment. FIG. 9B is a diagram illustrating an example of transmitting (a list of) cell IDs, using a gNB-DU Configuration Update message. Note that gNB-DU Configuration Update is used in update of application data necessary for accurate and mutual operation in an F1 interface between the gNB-DU and the gNB-CU. The gNB-DU Configuration Update message is a message used for performing such update.

As illustrated in FIG. 9B, in Step S3, the gNB-DU transmits a gNB-DU Configuration Update message including (a list of) cell IDs of cells to be added, changed, and/or deleted to the gNB-CU. In Step S4, the gNB-CU transmits a gNB-DU Configuration Update Acknowledge message including (a list of) cell IDs of cells to be activated or deactivated to the gNB-DU.

In this manner, OAM or the gNB-DU has the authority to determine the cell ID. Mainly, the gNB-CU controls whether to activate in response to a request from the gNB-DU.

### Operation Example of First Embodiment

The first embodiment includes a communication control method used in the cellular communication system 1. In the communication control method, a first communication node (for example, the source donor node 200-1) including a relay node (for example, the IAB node 300) thereunder makes an inquiry about cell Identities (IDs) available in the relay node to a second communication node (for example, the target donor node 200-2). In response to the inquiry, the second communication node determines the cell ID(s) not colliding with the cell IDs available in the second communication node from among the cell IDs available in the relay node, and transmits the determined cell ID(s) to the first communication node. The first communication node transmits the determined cell ID(s) to the relay node. The relay node executes movement processing by using the determined cell ID(s).

Specifically, the following is performed. That is, firstly, the source donor node 200-1 transmits a Handover Request message including cell IDs available in the IAB node 300 to the target donor node 200-2. The target donor node 200-2 determines the cell ID(s) not colliding with the cell IDs available in the target donor node 200-2 out of the cell IDs available in the IAB node 300. The target donor node 200-2 transmits a Handover Request Acknowledge message including the cell ID to the source donor node 200-1. The source donor node 200-1 transmits an RRC Reconfiguration (HO Command) message including the cell ID to the IAB node 300. The IAB node 300 executes movement processing (specifically, connection processing) to the target donor node 200-2, using the cell ID.

FIG. 10 is a diagram illustrating a specific example according to the first embodiment. FIG. 10 illustrates an example in which the IAB node 300 moves from the source donor node 200-1 to the target donor node 200-2.

As illustrated in FIG. 10, the source donor node 200-1 transmits cell IDs (PCI #2 and PCI #3) available in the IAB node 300 to the target donor node 200-2. The target donor node 200-2 determines the cell ID (PCI #3) not colliding with the cell ID (PCI #2) available in the target donor node 200-2 out of the cell IDs available for the IAB node 300. The target donor node 200-2 notifies the IAB node 300 of the determined cell ID (PCI #3) via the source donor node 200-1.

In this manner, in the first embodiment, the IAB node 300 receives, from the target donor node 200-2, the cell ID(s) not colliding with the cell IDs available in the target donor node 200-2 out of the cell IDs available in the IAB node 300. Thus, by performing the movement processing using the cell ID, PCI Collision can be reduced.

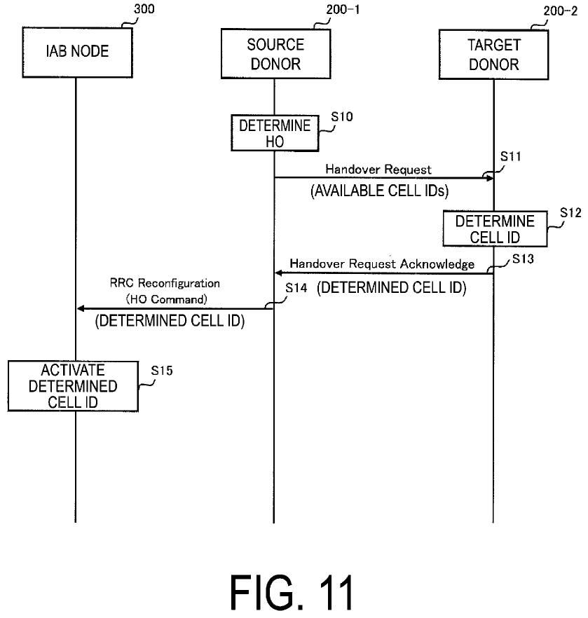

FIG. 11 is a diagram illustrating an operation example according to the first embodiment.

Note that cell IDs available for the station are configured for the IAB node 300 with OAM before the operation illustrated in FIG. 11 is performed.

The cell IDs may be a list of cell IDs. The list includes a plurality of cell IDs. The list may include cell IDs of active cells and cell IDs of inactive cells. Alternatively, the list may include cell IDs of one of the cell IDs of the active cells and the cell IDs of the inactive cells.

The cell IDs may be indicated by a range of available cell IDs. Examples of the range of available cell IDs include “PCI #1 to PCI #3”.

In this manner, the cell IDs may include a list of cell IDs and/or a range of cell IDs.

The IAB node 300 notifies the source donor node 200-1 of cell IDs available for the station before the operation illustrated in FIG. 11 is performed. The IAB-DU of the IAB node 300 may transmit an F1 Setup Request message including cell IDs available for the station to the CU of the source donor node 200-1. The IAB-DU of the IAB node 300 may transmit a gNB-DU Configuration Update message including cell IDs available for the station to the CU of the source donor node 200-1.

Note that the example illustrated in FIG. 11 assumes an Xn handover.

As illustrated in FIG. 11, in Step S10, the source donor node 200-1 determines to cause the IAB node 300 thereunder to perform migration (or handover, which may be hereinafter referred to as “handover”). The handover is a handover from the source donor node 200-1 to the target donor node 200-2.

In Step S11, the source donor node 200-1 transmits a Handover Request message including cell IDs available for the IAB node 300 to the target donor node 200-2. The available cell IDs may be a list of cell IDs. The available cell IDs may include information as to whether each of the cell IDs is activated or deactivated. Alternatively, the available cell IDs may be notified as cell IDs not allowed to be used. The transmission corresponds to making an inquiry about cell IDs available in the IAB node 300 to the target donor node 200-2. Note that the Handover Request message is an example of an Xn message.

In Step S12, in response to reception of the Handover Request message, the target donor node 200-2 determines the cell ID(s) not colliding with the cell IDs available in the target donor node 200-2 out of the IDs available for the IAB node 300.

In Step S13, the target donor node 200-2 transmits a Handover Request Acknowledge message including the determined cell ID(s) to the source donor node 200-1. The determined cell ID(s) may be a list of cell IDs. The determined cell ID(s) may include information as to whether each of the cell IDs is to be activated or deactivated. Alternatively, the determined cell ID(s) may be notified as cell ID(s) not allowed to be used. The Handover Request Acknowledge message is a response message for the Handover Request message, and is an example of an Xn message. The determined cell ID(s) may be included in an RRC message (for example, RRC Reconfiguration) generated by the target donor node 200-2. The determined cell ID(s) may be transmitted with the message being encapsulated (that is, stored in a container of the Xn message).

In Step S14, in response to reception of the Handover Request Acknowledge message, the source donor node 200-1 transmits an RRC Reconfiguration (HO Command) message including the determined cell ID(s) to the IAB node 300. The RRC Reconfiguration (HO Command) message is an example of an RRC message.

In Step S15, in response to reception of the RRC Reconfiguration (HO Command) message, the IAB node 300 activates the determined cell ID(s). The IAB node 300 initiates access to the target donor node 200-2 in conjunction with activation of the cell ID(s). Note that, in Step S15, the IAB node 300 may deactivate cell IDs other than the activated cell ID(s).

The example illustrated in FIG. 11 describes a case in which the IAB node 300 moves between the donor nodes 200-1 and 200-2 due to a handover. For example, it may be a case in which the IAB node 300 performs a handover between the parent nodes 300-P1 and 300-P2 of the IAB node 300. It may be a case in which the IAB node 300 performs a handover between upper nodes of the IAB node 300. It may be a case in which the IAB node 300 performs a handover between the gNB-CUs. In any of the cases, each message may be exchanged between the parent nodes 300-P1 and 300-P2, between the upper nodes, between the gNB-CUs, between the IAB node 300 and the parent node, between the IAB node 300 and the upper node, and between the DU of the IAB node 300 and the gNB-CU.

The following will describe a first other embodiment in the first embodiment, and such examples other than the handover between the donor nodes 200-1 and 200-2 may also be used in the embodiment.

### First Variation of First Embodiment

A first variation of the first embodiment will be described. The first embodiment describes an example in which the source donor node 200-1 makes an inquiry about cell IDs available in the IAB node 300 to the target donor node 200-2. The first variation of the first embodiment is an example in which the source donor node 200-1 makes the inquiry to the AMF 11.

Specifically, the following is performed. That is, firstly, the source donor node 200-1 transmits a first message including cell IDs available in the IAB node 300 to the AMF 11. The AMF 11 determines the cell ID(s) not colliding with the cell IDs available under the AMF 11 out of the cell IDs available in the IAB node 300. The AMF 11 transmits a second message including the determined cell ID(s) to the source donor node 200-1. The source donor node 200-1 transmits a Handover Command message including the determined cell ID(s) to the IAB node 300, and the IAB node 300 executes movement processing (specifically, connection processing) to the target donor node 200-2 by using the determined cell ID(s).

In the first variation as well, the IAB node 300 receives, from the AMF 11, the cell ID(s) not colliding with the cell IDs available under the AMF 11 out of the cell IDs available in the station. Thus, even when the IAB node 300 moves to the target donor node 200-2 under the AMF 11, PCI Collision can be reduced.

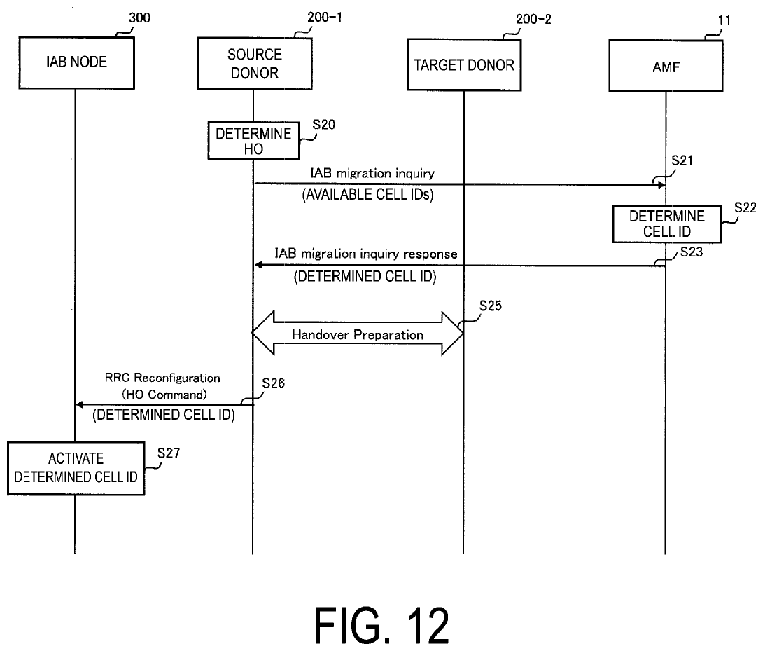

FIG. 12 is a diagram illustrating an operation example according to the first variation of the first embodiment. Pre-configuration in the operation example illustrated in FIG. 12 is also the same as and/or similar to that in the operation example (FIG. 11) of the first embodiment.

As illustrated in FIG. 12, in Step S20, the source donor node 200-1 determines to cause the IAB node 300 to perform a handover from the source donor node 200-1 to the target donor node 200-2.

In Step S21, the source donor node 200-1 transmits a first message including cell IDs available in the IAB node 300 to the AMF 11. The available cell IDs may be a list of cell IDs. The available cell IDs may include information as to whether each of the cell IDs is activated or deactivated. Alternatively, the available cell IDs may be notified as cell IDs not allowed to be used. The first message is an example of an NG message, and is a new message. The first message may be referred to as an IAB migration inquiry message. The transmission of the IAB migration inquiry message corresponds to making an inquiry about cell IDs available in the IAB node 300 to the AMF 11.

In Step S22, in response to reception of the IAB migration inquiry message, the AMF 11 determines the cell ID(s) not colliding with the cell IDs available under the AMF 11 out of the cell IDs available in the IAB node 300.

In Step S23, the AMF 11 transmits a second message including the determined cell ID(s) to the source donor node 200-1. The second message is also an example of an NG message, and is a new message. The second message may be referred to as an IAB migration inquiry Response message.

In Step S25, in response to reception of the IAB migration inquiry Response message, the source donor node 200-1 executes an Xn handover preparation procedure with the target donor node 200-2. The Xn handover preparation procedure includes transmission and reception of a Handover Request message and transmission and reception of a Handover Request Acknowledge message.

In Step S26, the source donor node 200-1 transmits an RRC Reconfiguration (HO Command) message including the cell ID(s) determined in the AMF 11 to the IAB node 300.

In Step S27, in response to reception of the RRC Reconfiguration (HO Command) message, the IAB node 300 activates the determined cell ID(s). The IAB node 300 initiates access to the target donor node 200-2, using the activated cell ID(s).

### Second Variation of First Embodiment

A second variation of the first embodiment will be described. The first embodiment and the first variation of the first embodiment describe examples of the Xn handover. The second variation of the first embodiment is an example of a case in which an NG handover is applied. In the Xn handover, the handover procedure is performed mainly between the donor nodes 200-1 and 200-2. In the NG handover, an apparatus included in the 5GC 10, such as the AMF 11, is also included in the handover procedure.

Specifically, the first communication node is an example of the source donor node 200-1, and the second communication node is an example of the AMF 11. The relay node is an example of the IAB node 300. Firstly, the source donor node 200-1 transmits a Handover Required message including cell IDs available in the IAB node 300 to the AMF 11. The AMF 11 determines the cell ID(s) not colliding with the cell IDs available under the AMF 11 out of the cell IDs available in the IAB node 300. The AMF 11 transmits a first Handover Command message including the determined cell ID(s) to the source donor node 200-1. The source donor node 200-1 transmits a second Handover Command message including the determined cell ID(s) to the IAB node 300, and the IAB node 300 executes connection processing to the target donor node 200-2 by using the determined cell ID(s).

In the second variation as well, the IAB node 300 receives, from the AMF 11, the cell ID(s) not colliding with the cell IDs available under the AMF 11 out of the cell IDs available in the station. Thus, even when the IAB node 300 moves to the target donor node 200-2 under the AMF 11, PCI Collision can be reduced.

Note that, in the second variation, the AMF 11 may be replaced with another apparatus (for example, the UPF 12) included in the 5GC 10.

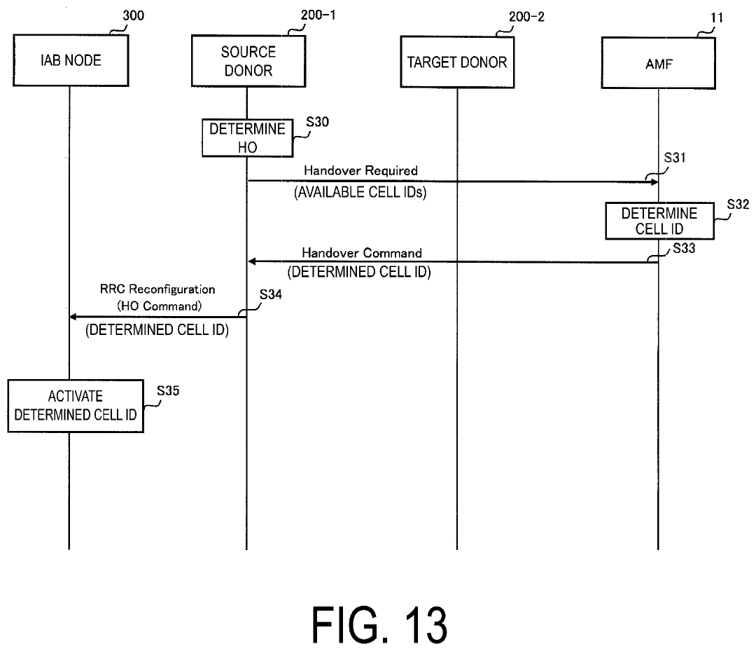

FIG. 13 is a diagram illustrating an operation example according to the second variation of the first embodiment. Pre-configuration in the operation example illustrated in FIG. 13 is also the same as and/or similar to that in the operation example (FIG. 11) of the first embodiment.

In Step S30, the source donor node 200-1 determines to cause the IAB node 300 to perform a handover from the source donor node 200-1 to the target donor node 200-2.

In Step S31, the source donor node 200-1 transmits a Handover Required message including cell IDs available in the IAB node 300 to the AMF 11. The Handover Required message is an NG protocol message. The available cell IDs may be a list of cell IDs. The available cell IDs may include information as to whether each of the cell IDs is activated or deactivated. Alternatively, the available cell IDs may be notified as cell IDs not allowed to be used.

In Step S32, in response to reception of the Handover Required message, the AMF 11 determines the cell ID(s) not colliding with the cell IDs available under the AMF 11 out of the cell IDs available in the IAB node 300.

In Step S33, the AMF 11 transmits a Handover Command message including the determined cell ID(s) to the source donor node 200-1. The Handover Command message is also an NG protocol message. Note that the AMF 11 performs exchange of messages related to the handover with the target donor node 200-2, but this is omitted in FIG. 13.

In Step S34, in response to reception of the Handover Command message, the source donor node 200-1 transmits an RRC Reconfiguration (HO Command) message including the determined cell ID(s) to the IAB node 300.

In Step S35, the IAB node 300 activates the cell ID(s) determined in the AMF 11, and performs movement processing, using the activated cell ID(s). Specifically, the IAB node 300 executes connection processing to the target donor node 200-2, using the cell ID(s).

### Third Variation of First Embodiment

A third variation of the first embodiment will be described. The third variation of the first embodiment is an example in which F1 Setup for the donor node 200-2 of the IAB node 300 is performed via the donor node 200-1. The third variation of the first embodiment illustrates an example in which such F1 Setup is performed in the handover procedure.

Specifically, the first communication node is illustrated as an example of the source donor node 200-1, and the second communication node is illustrated as an example of the target donor node 200-2. The relay node is illustrated as an example of the IAB node 300. Firstly, the source donor node 200-1 instructs the IAB node 300 to transmit an F1 Setup Request message. The IAB node 300 transmits a third message encapsulating the F1 Setup Request message to the source donor node 200-1. The F1 Setup Request message includes cell IDs available in the IAB node 300. The source donor node 200-1 transmits a Handover Request message encapsulating the F1 Setup Request message to the target donor node 200-2. The target donor node 200-2 extracts the cell IDs available in the IAB node 300 from the Handover Request message, and determines the cell ID(s) not colliding with the cell IDs available in the target donor node 200-2 out of the cell IDs. The target donor node 200-2 transmits a Handover Request Acknowledge message encapsulating an F1 Setup Response message including the determined cell ID(s) to the source donor node 200-1. The source donor node 200-1 transmits a Handover Command message encapsulating the F1 Setup Response message including the determined cell ID(s) to the IAB node 300. The IAB node 300 executes movement processing to the target donor node 200-2, using the cell ID(s) included in the F1 Setup Response message.

In this manner, in the third variation as well, the IAB node 300 receives, from the target donor node 200-2, the cell ID(s) not colliding with the cell IDs available in the target donor node 200-2 out of the cell IDs available in the station. Thus, even when the IAB node 300 performs a handover to the target donor node 200-2, PCI Collision can be reduced.

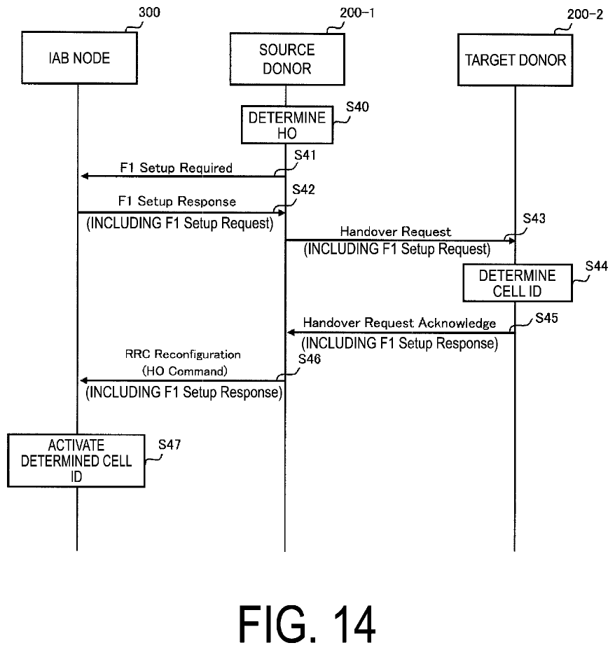

FIG. 14 is a diagram illustrating an operation example according to the third variation of the first embodiment. Pre-configuration and the like are the same as and/or similar to those in the first embodiment. The example illustrated in FIG. 14 illustrates an example of an Xn handover.

As illustrated in FIG. 14, the source donor node 200-1 determines to cause the IAB node 300 thereunder to perform a handover from the source donor node 200-1 to the target donor node 200-2.

In Step S41, the source donor node 200-1 instructs the IAB node 300 to transmit an F1 Setup Request message. Specifically, the CU of the source donor node 200-1 transmits an F1 Setup Required message to the IAB-MT of the IAB node 300. The F1 Setup Required message is a new RRC message indicating an instruction to transmit the F1 Setup Request message.

Note that the F1 Setup Required message may be an F1AP protocol message. In this case, the CU of the source donor node 200-1 transmits the message to the IAB-DU of the IAB node 300.

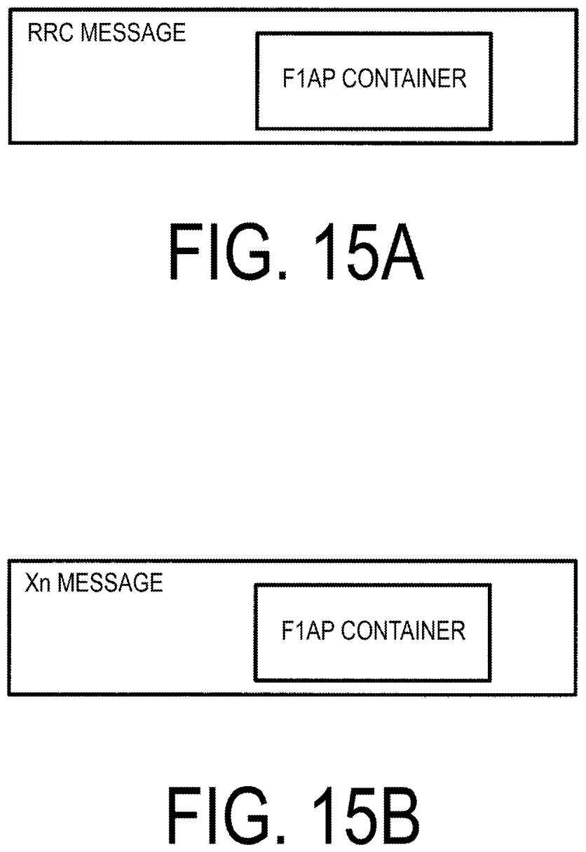

In Step S42, in response to reception of the F1 Setup Required message, the IAB-MT of the IAB node 300 transmits an F1 Setup Response message to the CU of the source donor node 200-1. The F1 Setup Response message is a response message for the F1 Setup Required message, and is a new RRC message. In this case, the IAB-MT of the IAB node 300 encapsulates the F1 Setup Request message in an F1AP container included in the message to thereby transmit the message. FIG. 15A illustrates an example of the F1AP container included in the message. The F1 Setup Request message includes the cell IDs available in the IAB node 300. Note that the F1 Setup Response message may be an F1AP protocol message.

Referring back to FIG. 14, note that, when the F1 Setup Required message is an RRC message, the IAB-MT of the IAB node 300 may notify the IAB-DU of the IAB node 300 of an acquisition instruction, and thereby acquire the F1 Setup Request message from the IAB-DU.

In Step S43, in response to reception of the F1 Setup Response message, the source donor node 200-1 transmits a Handover Request message to the target donor node 200-2. In this case, the source donor node 200-1 extracts the encapsulated F1 Setup Request message from the F1AP container of the F1 Setup Response message, and inserts the extracted F1 Setup Request message into an F1AP container of the Handover Request message. FIG. 15B illustrates an example of the F1AP container included in the Handover Request message (Xn message).

Referring back to FIG. 14, in Step S44, the target donor node 200-2 extracts the F1 Setup Request message from the F1AP container of the Handover Request message, and performs F1 Setup for the station. The target donor node 200-2 extracts the cell IDs available in the IAB node 300 from the F1 Setup Request message, and determines the cell ID(s) not colliding with the cell IDs available in the target donor node 200-2 out of the cell IDs.

In Step S45, the target donor node 200-2 transmits a Handover Request Acknowledge message to the source donor node 200-1. In this case, the target donor node 200-2 encapsulates an F1 Setup Response message including the determined cell ID(s) in an F1 container included in the Handover Request Acknowledge message (Xn message) to thereby perform transmission. The available cell IDs may be a list of cell IDs. The available cell IDs may include information as to whether each of the cell IDs is activated or deactivated. Alternatively, the available cell IDs may be notified as cell IDs not allowed to be used.

In Step S46, in response to reception of the Handover Request Acknowledge message, the source donor node 200-1 extracts the F1 Setup Response message from the F1 container of the Handover Request Acknowledge message. The source donor node 200-1 encapsulates the extracted F1 Setup Response message in an F1 container of an RRC Reconfiguration (HO Command) message. The CU of the source donor node 200-1 transmits the RRC Reconfiguration (HO Command) message including the encapsulated F1 Setup Response message to the IAB-MT of the IAB node 300.

In Step S47, the IAB node 300 extracts the F1 Setup Response message from the RRC Reconfiguration (HO Command) message, and extracts the cell ID(s) determined in the target donor node 200-2 from the F1 Setup Response message. The IAB node 300 activates the extracted cell ID(s). The IAB node 300 executes movement processing (specifically, connection processing) to the target donor node 200-2 in conjunction with activation of the cell ID(s).

### Second Embodiment

A second embodiment will be described.

As described in the first embodiment, the cell ID used in the IAB node 300 may be changed due to migration of the IAB node 300. A child node 300-C with its parent node being the IAB node 300 and/or the UE 100 cannot know a changed cell ID in the parent node (IAB node 300). On the other hand, when the child node 300-C and/or the UE 100 uses the changed cell ID, the child node 300-C and/or the UE 100 performs cell reselection processing or RRC Connection Reestablishment (RRC connection reconfiguration) processing for the cell ID.

However, when all of the child nodes 300-C of the IAB node 300 and/or the UEs 100 simultaneously initiate the RRC connection reconfiguration processing, this may cause collision of RACH preambles or cause overall resources to run short. Thus, a service being provided to the UE 100 may be interrupted.

The second embodiment has an object to reduce processing accompanied by the change of the cell ID of the parent node for the child node 300-C and/or the UE 100.

Thus, in the second embodiment, the relay node (for example, the IAB node 300-P) detects a fact that the cell currently in use is to become unavailable. The relay node transmits the cell ID of the cell to become unavailable to the child node (for example, the child node 300-C) of the relay node and/or the user equipment (for example, the UE 100).

Thus, for example, even when the child node 300-C and/or the UE 100 receives the cell ID of the cell to become unavailable, the child node 300-C and/or the UE 100 at least arranges not to perform cell reselection processing, RRC connection reconfiguration processing, and Radio Link Failure (RLF) processing, and can thereby reduce processing accompanied by the change of the cell ID.

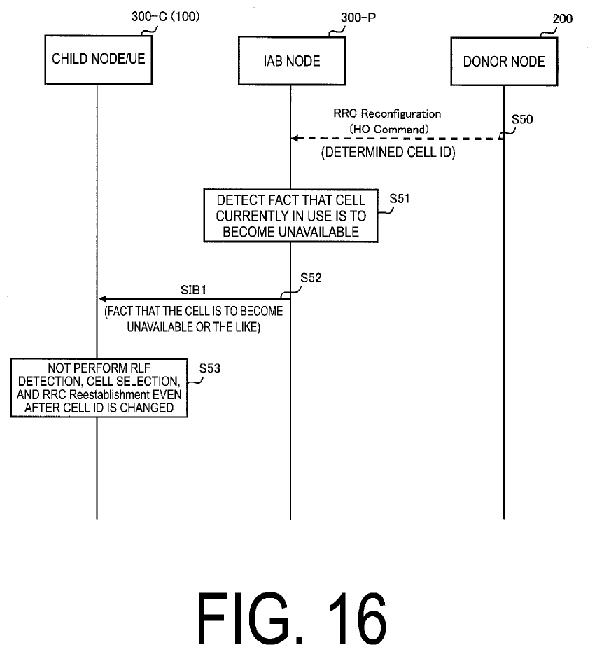

FIG. 16 is a diagram illustrating an operation example according to the second embodiment. FIG. 16 illustrates an example in which the IAB node 300-P is present under the donor node 200. FIG. 16 illustrates an example in which the IAB node 300-C is present as a child node of the IAB node 300-P and/or the UE 100 connected to the IAB node 300-P with an access link is present.

In Step S50, the IAB node 300-P may receive an RRC Reconfiguration (HO Command) message including a changed cell ID from the donor node 200. Step S50 may be Step S14 (FIG. 11) of the first embodiment, Step S26 (FIG. 12) of the first variation of the first embodiment, Step S34 (FIG. 13) of the second variation of the first embodiment, Step S46 (FIG. 14) of the third variation of the first embodiment, or the like. The changed cell ID may be replaced with an available cell ID, an unavailable cell ID, a cell ID to be activated, or a cell ID to be deactivated. The donor node 200 may be replaced with a parent node or an upper node of the IAB node 300-P.

In Step S51, the IAB node 300-P detects a fact that the cell currently in use is to become unavailable. The IAB node 300-P may detect the fact that the cell currently in use is to become unavailable, in reaction to reception of a notification (for example, Step S50) that the cell currently in use is to be deactivated (or to become unavailable) from the donor node 200. Alternatively, the IAB node 300-P may detect the fact that the cell currently in use is to become unavailable, in reaction to reception of a notification of the changed cell ID in Step S50. Note that, when the IAB node 300-P can continuously use the cell currently in use, the IAB node 300-P continues to use the cell ID of the cell. The following processing assumes a case in which the cell currently in use has become unavailable.

In Step S52, the IAB node 300-P transmits the cell ID of the cell to become unavailable for continuous use to the child node 300-C and/or the UE 100.

In this case, the IAB node 300-P may broadcast SIB1 including the cell ID to thereby perform the transmission. The IAB node 300-P may transmit an RRC message, an F1AP message, or the like including the cell ID to thereby perform the transmission.

As contents of the notification as well, instead of the cell ID of the cell to become unavailable for continuous use, information indicating that the cell is to become unavailable, information indicating that the cell ID of the cell is to be changed, or timing information may be included. The information indicating that the cell ID of the cell is to be changed may include the changed cell ID. The changed cell ID itself may be the information itself indicating that the cell ID of the cell is to be changed. The timing information may be information indicating a timing of deactivation or information indicating a timing of change of the cell ID. The timing itself may be indicated by a System Frame Number (SFN) and/or time (one second or the like).

In Step S53, in response to reception of the cell ID, even when the cell ID of the cell currently in use is changed, the child node 300-C and/or the UE 100 arranges not to perform predetermined processing. The predetermined processing includes at least one selected from the group consisting of the RLF detection, the cell reselection processing, and the RRC connection reconfiguration processing. With the child node 300-C and/or the UE 100 not performing the predetermined processing, processing accompanied by the change of the cell ID can be reduced. In this case, as a soft handover, the child node 300-C and/or the UE 100 may recognize change of the cell ID, and continuously use configuration processing for the cell and the like as they are.

Note that, in Step S53, the child node 300-C and/or the UE 100 may perform the RRC connection reconfiguration processing after the cell ID is changed. Note that, in order to reduce processing accompanied by the change of the cell ID, the child node 300-C and/or the UE 100 may perform a RACH-less handover for a new cell ID.

Step S53 describes an operation based on an assumption that the child node 300-C and/or the UE 100 is in the RRC connected state with the IAB node 300-P. For example, when the child node 300-C and/or the UE 100 is in the idle state or the inactive state, the child node 300-C and/or the UE 100 performs the cell reselection processing for the new cell ID. Thus, the operation example illustrated in FIG. 16 may be based on an assumption that the child node 300-C and/or the UE 100 is in the idle state or the inactive state.

### Third Embodiment

A third embodiment will be described.

The second embodiment describes an example in which the child node 300-C and/or the UE 100 is notified of a fact that the cell ID of the cell currently in use is to become unavailable in the IAB node 300-P. In this case, when the child node 300-C and/or the UE 100 immediately performs handover processing in reaction to such a notification, the child node 300-C and/or the UE 100 may initiate the handover processing before completing the change of the cell ID in the station. Particularly, the IAB node 300 that has received the HO Command described in the first embodiment may perform the handover processing before changing the cell ID without a sufficiency of time.

The third embodiment will describe an example in which the IAB node 300 performs a handover using a conditional handover including time in a trigger condition. Such a conditional handover may be referred to as a Time-triggered Conditional Handover (CHO).

Specifically, the source donor node 200-1 transmits a request message for making a request about a conditional handover including time in the trigger condition to the target donor node 200-2. In response to reception of the request message, the target donor node 200-2 transmits an accept message for accepting the request to the source donor node 200-1. In response to reception of the accept message, the source donor node 200-1 configures the relay node (for example, the IAB node 300) to execute the conditional handover including time in the trigger condition.

Thus, for example, even when the IAB node 300 receives a notification (Step S52 of FIG. 16) of change of the cell ID from the source donor node 200-1, the IAB node 300 can execute the handover processing after the time has elapsed. Thus, for example, the IAB node 300 can execute the handover processing after changing the cell ID, and can therefore appropriately perform the handover processing.

The conditional handover will be described.

Conditional Handover

The conditional handover is handover performed when one or more handover execution conditions (or trigger conditions) are met. The configuration of the conditional handover includes a candidate cell for handover and a handover trigger condition. The configuration of the conditional handover may include multiple combinations of a candidate cell and a trigger condition.

As the trigger condition, for example, an event referred to as event A3 and/or an event referred to as event A5 is specified. The event A3 is an event where the radio state of the neighbor cell is better than the radio state of the serving cell by a predetermined amount (predetermined offset) or more. The event A5 is an event where the radio state of the serving cell is worse than a first threshold, and the radio state of the neighbor cell is better than a second threshold.

In the third embodiment, as described above, time (or a sufficiency of time; which may be hereinafter referred to as a “sufficiency of time”) is included in the trigger condition of the conditional handover.

### Operation Example of Third Embodiment

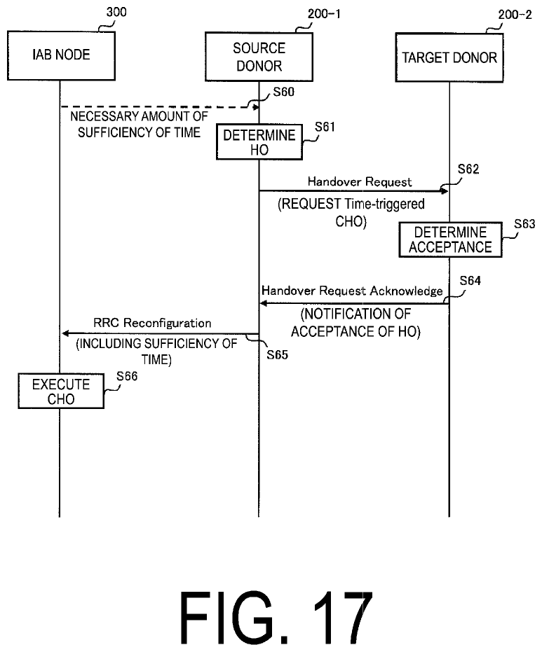

FIG. 17 is a diagram illustrating an operation example according to the third embodiment. FIG. 17 illustrates an example of a case in which the IAB node 300 performs a handover from the source donor node 200-1 to the target donor node 200-2.

As illustrated in FIG. 17, in Step S60, the IAB node 300 may notify the source donor node 200-1 of a necessary amount of a sufficiency of time. For example, the IAB node 300 may include the necessary amount of the sufficiency of time in an RRC message or an F1AP message to thereby perform transmission.

The necessary amount of the sufficiency of time is time required when the IAB node 300 executes a conditional handover including time in the trigger condition, for example. The necessary amount of the sufficiency of time may be indicated by an SFN and/or a time unit (one second or the like).

In Step S61, the source donor node 200-1 determines to cause the IAB node 300 to perform a handover from the source donor node 200-1 to the target donor node 200-2.

In Step S62, the source donor node 200-1 requests a conditional handover including time in the trigger condition. The source donor node 200-1 may transmit the request, using a Handover Request message. The Handover Request message may be a request message for making a request about the conditional handover to the target donor node 200-2. The source donor node 200-1 may transmit the necessary amount of the sufficiency of time together with the request. The necessary amount of the sufficiency of time of the IAB node 300 may be stored in the source donor node 200-1 in advance. The necessary amount of the sufficiency of time of the IAB node 300 may be received from the IAB node 300 as in Step S60.

In Step S63, in response to reception of the request for the conditional handover, the target donor node 200-2 determines to accept the conditional handover. When the request includes the necessary amount of the sufficiency of time, the target donor node 200-2 may determine an amount of the sufficiency of time with respect to the necessary amount. Note that, when the request does not include the necessary amount of the sufficiency of time, an amount of the sufficiency of time may be determined with respect to the necessary amount of the sufficiency of time in the source donor node 200-1.

Note that the amount of the sufficiency of time may be time actually used in the conditional handover with respect to the necessary amount of the sufficiency of time, for example. The amount of the sufficiency of time may also be indicated by an SFN or indicated by a time unit, for example.

In Step S64, the target donor node 200-2 transmits acceptance of the conditional handover to the source donor node 200-1. The target donor node 200-2 may transmit the acceptance of the conditional handover, using a Handover Request Acknowledge message.

The Handover Request Acknowledge message may be an accept message for accepting the request. Note that, when the target donor node 200-2 determines the amount of the sufficiency of time, the target donor node 200-2 includes the determined amount of the sufficiency of time in the Handover Request Acknowledge message to thereby perform transmission. The Handover Request Acknowledge message includes RRC Reconfiguration configuration.

In Step S65, in response to reception of the acceptance of the conditional handover, the source donor node 200-1 configures the conditional handover for the IAB node 300. For example, the source donor node 200-1 transmits an RRC Reconfiguration message to the IAB node 300, and thereby performs the configuration. The RRC Reconfiguration message includes the amount of the sufficiency of time determined in the source donor node 200-1 or the target donor node 200-2. The RRC Reconfiguration message includes the RRC Reconfiguration configuration received in Step S64.

In the IAB node 300, the amount of the sufficiency of time is configured as the trigger condition used for the conditional handover. Here, the amount of the sufficiency of time has two meanings.

In a first case, the IAB node 300 evaluates the trigger condition (for example, event A3 or the like) of the conditional handover after the amount of the sufficiency of time has elapsed since predetermined time. In this case, the amount of the sufficiency of time indicates the sufficiency of time before monitoring of the trigger condition is started. For example, after one second (the amount of the sufficiency of time) has elapsed since the predetermined time, the IAB node 300 starts monitoring of another trigger condition (for example, event A3) of the conditional handover, and when such another trigger condition is met, the IAB node 300 initiates access to the target donor node 200-2.

In a second case, the handover is executed after the amount of the sufficiency of time has elapsed. In this case, the amount of the sufficiency of time corresponds to the trigger condition. For example, after one second (the amount of the sufficiency of time) has elapsed since the predetermined time, the IAB node 300 initiates access to the target donor node 200-2.

Note that, when the conditional handover including time in the trigger condition is configured, the IAB node 300 may stop evaluation of the conditional handover according to another condition (for example, a change of the radio state) while the time elapses (for example, while a corresponding timer is running). Thus, unintended access to another cell (execution of another conditional handover) during the sufficiency of time can be forestalled.

Note that the predetermined time may be time when the IAB node 300 receives the RRC Reconfiguration message (Step S65). The predetermined time may be time configured from the donor nodes 200-1 and 200-2.

In Step S66, the IAB node 300 executes the conditional handover.

### Fourth Embodiment

A fourth embodiment will be described.

The fourth embodiment is an example in which the IAB node 300 broadcasts the cell ID of the cell currently in use and a new cell ID to the child node 300-C and/or the UE 100.

Specifically, the relay node (for example, the IAB node 300) broadcasts a first cell ID indicating the cell ID currently in use and a second cell ID indicating a changed cell ID. The relay node causes the child node (for example, the child node 300-C) of the relay node and/or the user equipment (for example, the UE 100) accessing the cell of the first cell ID to perform a handover to the cell of the second cell ID. After the relay node causes the child node and/or the user equipment to perform the handover, the relay node stops broadcasting the first cell ID.

Thus, the child node 300-C and/or the UE 100 can recognize the cell ID currently in use and the new changed cell ID, and can subsequently appropriately perform handover processing.

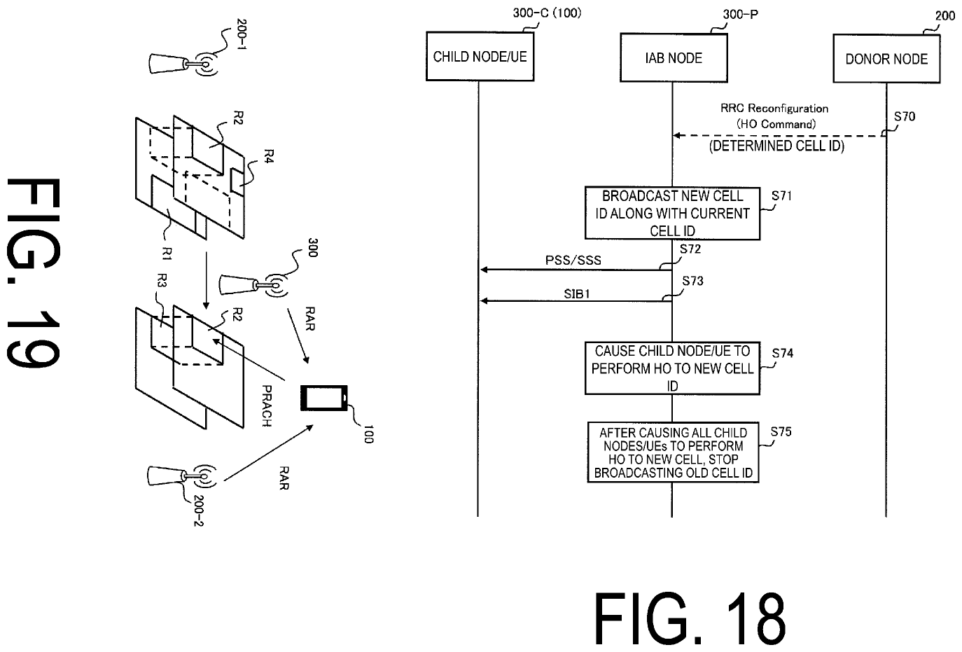

FIG. 18 is a diagram illustrating an operation example according to the fourth embodiment.

As illustrated in FIG. 18, in Step S70, the IAB node 300-P may receive a changed cell ID from the donor node 200 at the time of migration. The changed cell ID may be replaced with an available cell ID, an unavailable cell ID, a cell ID to be activated, or a cell ID to be deactivated. Step S70 may be Step S14 (FIG. 11) of the first embodiment, Step S26 (FIG. 12) of the first variation of the first embodiment, Step S34 (FIG. 13) of the second variation of the first embodiment, Step S46 (FIG. 14) of the third variation of the first embodiment, or the like.

In Step S71, the IAB node 300-P broadcasts the cell ID of a new cell along with the cell ID of the cell currently in use. The cell ID of the new cell refers to the cell ID of the cell to be newly accessed due to a handover of the IAB node 300-P, for example. The cell ID of the new cell may be the changed cell ID that is different from the cell ID currently used by the IAB node 300-P.

In Step S72, the IAB node 300-P may broadcast the PSS and the SSS, and thereby broadcast the PCI currently in use and a new PCI.

In Step S73, the IAB node 300-P may broadcast the Cell ID currently in use and a new Cell ID, using SIB1.

In Step S74, the IAB node 300-P causes the child node 300-C and/or the UE 100 to perform a handover from the cell currently in use to the new cell. In this case, the IAB node 300-P may configure a RACH-less handover. Alternatively, the IAB node 300-P may configure a soft handover (Step S53 of FIG. 16) described in the second embodiment.

In Step S75, after the IAB node 300-P causes all of the child nodes 300-C thereunder and/or the UEs 100 to perform the handover to the new cell, the IAB node 300-P stops broadcasting the cell ID of the cell currently in use. For example, when the IAB node 300-P receives a handover complete message from all of the child nodes 300-C thereunder and/or the UEs 100, the IAB node 300-P stops broadcasting the cell ID of the cell currently in use.

### Fifth Embodiment

A fifth embodiment will be described.

The first embodiment describes a case in which PCI Collision occurs due to migration of the IAB node 300. The fifth embodiment will describe an example of a case in which Physical Random Access Channel (PRACH) resources collide due to migration of the IAB node 300.

FIG. 19 is a diagram illustrating an example of collision between PRACH resources according to the fifth embodiment. FIG. 19 illustrates an example of a case in which the IAB node 300 performs a handover from the source donor node 200-1 to the target donor node 200-2.

Before the IAB node 300 performs a handover, the IAB node 300 is located at a position near the donor node 200-1. A PRACH resource R2 of the IAB node 300-2 and a PRACH resource R1 of the IAB node 300-1 conform to resource mapping without collision. Thus, the UE 100 located between the donor node 200-1 and the IAB node 300 can execute a random access procedure with the donor node 200-1, and thereby connect to the donor node 200-1. The UE 100 can execute a random access procedure with the IAB node 300, and thereby connect to the IAB node 300 as well.

On the other hand, when the IAB node 300 performs a handover, the IAB node 300 moves to a position near the donor node 200-2. This causes resource ranges of the PRACH resource R2 of the IAB node 300 and a PRACH resource R3 of the donor node 200-2 to overlap. Thus, even when the UE 100 transmits a RACH preamble (message 1) using the PRACH resource R2, the IAB node 300 may not be able to receive the RACH preamble due to interference. If the IAB node 300 and the donor node 200-2 both receive the RACH preamble transmitted from the UE 100, the IAB node 300 and the donor node 200-2 both transmit a RACH response (message 2) to the UE 100. Because the UE 100 receives the RACH responses from the both, the UE 100 falls into a state of uncertainty. Thus, the UE 100 fails in the random access procedure with the IAB node 300, resulting in failing to connect to the IAB node 300.

In contrast, in the fifth embodiment, firstly, based on PRACH configuration of a neighboring node received from the neighboring node neighboring the first communication node, the first communication node (for example, the source donor node 200-1) determines the PRACH configuration not colliding with the PRACH configuration of the neighboring node. The first communication node transmits the determined PRACH configuration to the relay node (for example, the IAB node 300). The source donor node 200-1 executes handover processing with the target donor node 200-2, and the relay node applies the determined PRACH configuration to the target donor node 200-2.

For example, in the example of FIG. 19, the source donor node 200-1 receives the PRACH configuration (for example, the PRACH resource R3) of the target donor node 200-2 as the PRACH configuration of the neighboring node. The source donor node 200-1 determines the PRACH configuration (for example, a PRACH resource R4) that does not overlap the PRACH configuration (for example, the PRACH resource R1) of the station and the PRACH configuration (for example, the PRACH resource R3) of the target donor node 200-2. The source donor node 200-1 transmits the PRACH configuration to the IAB node 300.

Even when the IAB node 300 applies the PRACH configuration to the target donor node 200-2, the IAB node 300 can appropriately access the target donor node 200-2, because none of the PRACH resources overlaps. Thus, the source donor node 200-1 can control the resources to reduce overlapping of the PRACH resources.

Note that, although the example of FIG. 19 describes an example in which the source donor node 200-1 determines the PRACH configuration, the target donor node 200-2 may determine the PRACH configuration. The latter case will be described in a first variation of the fifth embodiment.

Notification of PRACH Configuration Here, an example of notification of the PRACH Configuration will be described. The PRACH configuration indicates the PRACH resources in the cell. Specifically, the PRACH configuration includes a resource start frequency, a subcarrier spacing (SCS), and a frequency domain length.

The gNB-DU can include the PRACH configuration of each cell in an F1 Setup Response message to thereby perform transmission to the gNB-CU. The gNB-DU can include the PRACH configuration of each cell in a gNB-DU Configuration Update message to thereby perform transmission to the gNB-CU.

The gNB-CU can also notify the CU of another gNB of the PRACH configuration for the sake of RACH Optimization. Thus, the source donor node 200-1 can receive the PRACH configuration of the target donor node 200-2 from the target donor node 200-2. The target donor node 200-2 can also receive the PRACH configuration of the source donor node 200-1 from the source donor node 200-1.

### Operation Example of Fifth Embodiment

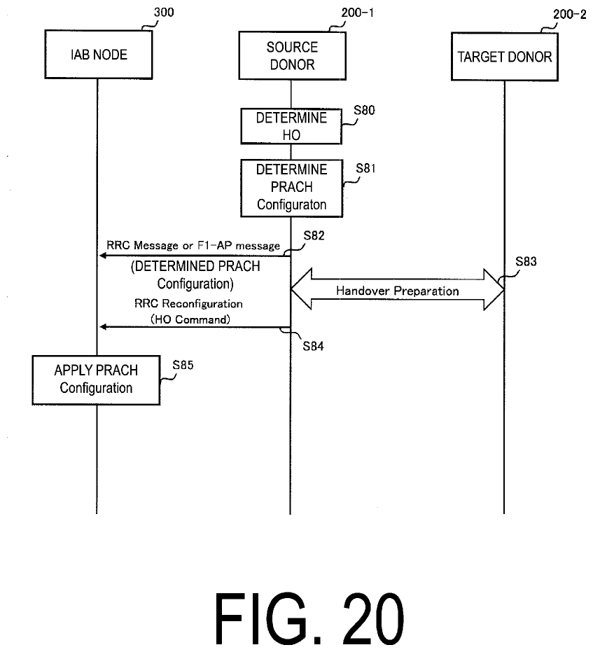

An operation example of the fifth embodiment will be described. FIG. 20 is a diagram illustrating an operation example according to the fifth embodiment. Note that the source donor node 200-1 receives the PRACH configuration of the target donor node 200-2 as the PRACH configuration of a neighboring donor node before the operation example illustrated in FIG. 20 is performed.

Note that the following operation example will describe an example in which the IAB node 300 performs a handover between the donor nodes 200-1 and 200-2. Note that other examples may be applied, in a manner the same as and/or similar to the first embodiment. That is, it may be a case in which the IAB node 300 performs a handover between the parent nodes 300-P1 and 300-P2. It may be a case in which the IAB node 300 performs a handover between upper nodes. It may be a case in which the IAB node 300 performs a handover between the gNB-CUs. In any of the cases, each message may be exchanged between the parent nodes 300-P1 and 300-P2, between the upper nodes, between the gNB-CUs, between the IAB node 300 and the parent node, between the IAB node 300 and the upper node, and between the DU of the IAB node 300 and the gNB-CU.

As illustrated in FIG. 20, in Step S80, the source donor node 200-1 determines that the IAB node 300 is to perform a handover from the source donor node 200-1 to the target donor node 200-2.

In Step S81, the source donor node 200-1 determines the PRACH configuration of the IAB node 300, based on the PRACH configuration of a neighboring donor node. Specifically, the source donor node 200-1 determines the PRACH configuration in which the PRACH configuration of the target donor node 200-2 and the PRACH configuration of the source donor node 200-1 do not collide.

In Step S82, the source donor node 200-1 transmits the determined PRACH configuration to the IAB node 300. The source donor node 200-1 may transmit an RRC message including the PRACH configuration and/or an F1AP message including the PRACH configuration. In this case, the source donor node 200-1 may include an identifier indicating that the PRACH configuration is to be applied after the handover in the message to thereby perform transmission. Even when the IAB node 300 receives the determined PRACH configuration, the IAB node 300 may defer application of the PRACH configuration until completion of the handover to the target donor node 200-2. Alternatively, when the IAB node 300 receives the PRACH configuration, the IAB node 300 may immediately apply the PRACH configuration.

In Step S83, the source donor node 200-1 executes a Handover Preparation procedure with the target donor node 200-2.

In Step S84, when the source donor node 200-1 ends the Handover Preparation procedure, the source donor node 200-1 transmits an RRC Reconfiguration (HO Command) message to the IAB node 300.

In Step S85, in response to reception of the RRC Reconfiguration (HO Command) message, the IAB node 300 applies the PRACH configuration received in Step S82. The IAB node 300 may apply the PRACH configuration at the time of reception of the message, at the time of initiation of access to the target donor node 200-2, or at the time of completion of the access, for example.

### First Variation of Fifth Embodiment

A first variation of the fifth embodiment will be described.

The fifth embodiment describes an example in which the source donor node 200-1 determines the PRACH configuration in which collision of resources does not occur. The first variation of the fifth embodiment is an example in which the target donor node 200-2 determines the PRACH configuration in which collision of resources does not occur.

Specifically, based on Physical Random Access Channel (PRACH) configuration of a neighboring cell received from a neighboring node neighboring the first communication node, the first communication node (for example, the target donor node 200-2) determines the PRACH configuration not colliding with the PRACH configuration of the neighboring cell. The first communication node transmits the determined PRACH configuration to the relay node (for example, the IAB node 300).

In the first variation of the fifth embodiment as well, in a manner the same as and/or similar to the fifth embodiment, even when the IAB node 300 applies the PRACH configuration and accesses the target donor node 200-2, the IAB node 300 can appropriately perform access, because the PRACH configurations do not overlap. Thus, in the first variation of the fifth embodiment as well, the target donor node 200-2 can control the resources to reduce overlapping of the PRACH resources.

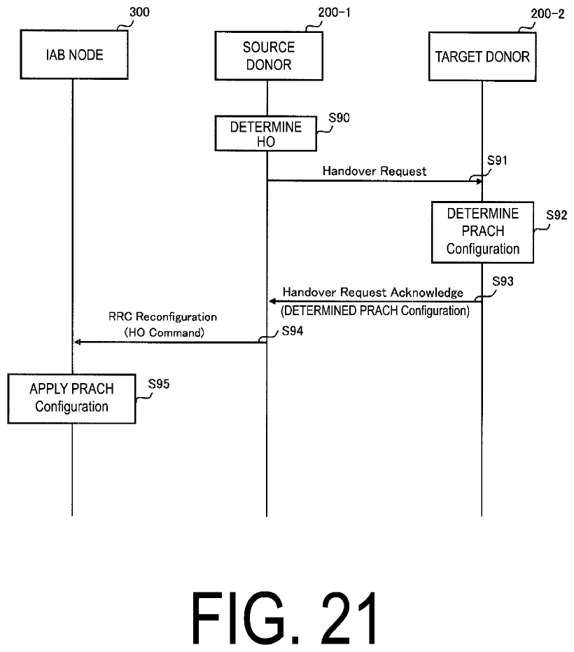

FIG. 21 is a diagram illustrating an operation example according to the first variation of the fifth embodiment. Note that the target donor node 200-2 receives the PRACH configuration of the source donor node 200-1 as the PRACH configuration of a neighboring donor node before the operation example illustrated in FIG. 21 is performed.

As illustrated in FIG. 21, in Step S90, the source donor node 200-1 determines that the IAB node 300 is to perform a handover.

In Step S91, the source donor node 200-1 transmits a Handover Request message to the target donor node 200-2. In this case, the source donor node 200-1 may include the PRACH configuration of the IAB node 300 in the Handover Request message to thereby perform transmission. This is because the target donor node 200-2 may not receive the PRACH configuration of the source donor node 200-1 as the PRACH configuration of a neighboring donor node in advance.

In Step S92, the target donor node 200-2 determines the PRACH configuration of the IAB node 300, based on the PRACH configuration of a neighboring cell. Specifically, the target donor node 200-2 determines the PRACH configuration in which the PRACH configuration of the source donor node 200-1 and the PRACH configuration of the target donor node 200-2 do not collide.

In Step S93, the target donor node 200-2 transmits a Handover Request Acknowledge message including the determined PRACH configuration to the source donor node 200-1.

In Step S94, in response to reception of the Handover Request Acknowledge message, the source donor node 200-1 transmits an RRC Reconfiguration (HO Command) message including the determined PRACH configuration to the IAB node 300.

In Step S95, the IAB node 300 applies the PRACH configuration determined in the target donor node 200-2. In a manner the same as and/or similar to the fifth embodiment, the IAB node 300 may apply the PRACH configuration at the time of reception of the RRC Reconfiguration (HO Command) message, at the time of initiation of access to the target donor node 200-2, or at the time of completion of the access.

### Second Variation of Fifth Embodiment

A second variation of the fifth embodiment will be described.

The fifth embodiment and the first variation of the fifth embodiment describe an example of a case in which the IAB node 300 performs a handover. The second variation of the fifth embodiment will describe an example after power of the IAB node 300 is turned on, instead of the handover.

Specifically, firstly, the relay node (for example, the IAB node 300) turns on its power. The relay node transmits an F1 Setup Request message to the donor node (for example, the donor node 200). Based on the PRACH configuration of a neighboring donor node and the PRACH configuration of the relay node included in the F1 Setup Request, the donor node determines the PRACH configuration not colliding with the PRACH configuration of a neighboring cell. The donor node transmits an F1 Setup Response message including the determined PRACH configuration to the relay node.

The IAB node 300 receives, from the donor node 200, the PRACH configuration not colliding with the neighboring donor node in the donor node 200, and can thus appropriately perform a random access procedure with the donor node 200, using the PRACH configuration. Thus, in the second variation of the fifth embodiment as well, the target donor node 200-2 can control the resources to reduce overlapping of the PRACH resources.

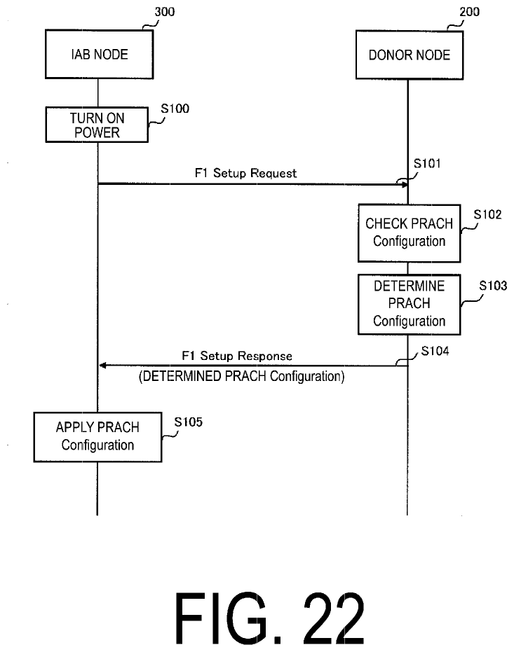

FIG. 22 is a diagram illustrating an operation example according to the second variation of the fifth embodiment. Note that, in the operation example illustrated in FIG. 22 as well, the donor node 200 receives the PRACH configuration of a neighboring donor node as pre-configuration.

As illustrated in FIG. 22, in Step S100, the IAB node 300 turns on its power. Instead of turning on the power, the IAB node 300 may receive RRC Reconfiguration (HO Command), and establish RRC connection with the donor node 200.

In Step S101, the IAB node 300 transmits an F1 Setup Request message to the donor node 200. The message includes a PRACH configuration of the IAB node 300. In a case of the Mobile IAB, the message may invariably include the PRACH configuration.

In Step S102, the donor node 200 checks the PRACH configuration of the IAB node 300, based on the PRACH configuration of a neighboring donor node. Specifically, the donor node 200 checks whether the PRACH configuration of the IAB node 300 collides with the PRACH configuration of the neighboring donor node. When collision does not occur, the donor node 200 ends without performing the following processing. The following description is based on an assumption that collision occurs.

In Step S103, the donor node 200 determines the PRACH configuration not colliding with the PRACH configuration of the neighboring donor node. Specifically, the donor node 200 determines the PRACH configuration in which the donor node 200 and the PRACH configuration of the neighboring donor node do not collide.

In this case, instead of determining the PRACH configuration, the donor node 200 may transmit an F1 Setup Failure message to the IAB node 300. In this case, the donor node 200 may include a Cause indicating that the PRACH configuration of the IAB node 300 is unacceptable or that the PRACH configuration collides in the F1 Setup Failure message to thereby perform transmission. When the IAB node 300 receives the F1 Setup Failure message, the IAB node 300 may reconsider another PRACH configuration. The IAB node 300 may transmit another PRACH configuration to the donor node 200, and repeat Step S101 and subsequent steps.

In Step S104, the donor node 200 transmits an F1 Setup Response message including the determined PRACH configuration to the IAB node 300.

In Step S105, the IAB node 300 applies the PRACH configuration determined in the donor node 200. The IAB node 300 may apply the PRACH configuration at the time of initiation of access to the donor node 200 or at the time of completion of the access.

The operation example illustrated in FIG. 12 describes an example of the F1 Setup Request message (Step S101) and the F1 Setup Response message (Step S104).

The F1 Setup Request message may be replaced with a gNB-DU Configuration Update message, and the F1 Setup Response message may be replaced with a gNB-DU Configuration Update Acknowledge message. In this case, the gNB-DU Configuration Update message includes the PRACH configuration of the IAB node 300, and the gNB-DU Configuration Update Acknowledge message includes the determined PRACH configuration.

The F1 Setup Request message may be replaced with a gNB-CU Configuration Update message, and the F1 Setup Response message may be replaced with a gNB-DU Configuration Update Acknowledge message. In this case, the gNB-CU Configuration Update message includes the PRACH configuration of the IAB node 300, and the gNB-DU Configuration Update Acknowledge message includes the determined PRACH configuration.

### OTHER EMBODIMENTS

A program causing a computer to execute each type of processing performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each type of processing to be performed by the UE 100, the gNB 200, or the IAB node 300 may be integrated, and at least part of the UE 100, the gNB 200, or the IAB node 300 may be configured as a semiconductor integrated circuit (a chipset or a System on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1: Mobile communication system
10: 5GC
11: AMF
100: UE
110: Wireless communicator
120: Controller
200 (200-1, 200-2): gNB (donor node)
210: Wireless communicator
220: Network communicator
230: Controller
300: IAB node
310: Wireless communicator
320: Controller

1. A communication control method used in a cellular communication system, the communication control method comprising:
being configured with a first cell ID which is usable in a movable mobile IAB node from an OAM, by the mobile IAB node;
transmitting, by a target donor node, a Handover Request Acknowledgement message including an F1 message to a source donor node;
transmitting, by the source donor node, to the mobile IAB node a Handover Command message including the F1 message in response to the reception of the Handover Request Acknowledgement message; and
activating, by the mobile IAB node, a second cell ID including the F1 message, wherein
the second cell ID is a cell ID not colliding with the first cell ID out of the cell ID available in the target donor node.

2. The communication control method according to claim 1, wherein
the cell ID is a physical cell ID (PCI).

3. A cellular communication system comprising;
a movable mobile IAB node;
a source donor node; and
a target donor node, wherein
the mobile IAB node is configured with a first cell ID which is usable in the mobile IAB node from an OAM,
the target donor node transmits a Handover Request Acknowledgement message including an F1 message to the source donor node,
the source donor node transmits to the mobile IAB node a Handover Command message including the F1 message in response to the reception of the Handover Request Acknowledgement message,
the mobile IAB node activates a second cell ID including the F1 message, and
the second cell ID is a cell ID not colliding with the first cell ID out of the cell ID available in the target donor node.

4. The cellular communication system according to claim 3, wherein
the cell ID is a physical cell ID (PCI).

5. A mobile IAB node movable in a cellular communication system, the mobile IAB node comprising;
a controller circuitry configured to be configured with a first cell ID which is usable in the movable IAB node from an OAM; and
a receiver circuitry configured to receive a Handover Command message including an F1 message from a donor node, wherein
the controller is configured to activate a second cell ID including the F1 message, and
the second cell ID is a cell ID not colliding with the first cell ID out of the cell ID available in the donor node.

6. The mobile IAB node according to claim 5, wherein
the cell ID is a physical cell ID (PCI).

7. A non-transitory computer-readable storage medium storing a program for causing a computer to execute processing comprising:
being configured with a first cell ID which is usable in a movable IAB node from an OAM;
receiving a Handover Command message including an F1 message from a donor node; and
activating a second cell ID including the F1 message, wherein
the second cell ID is a cell ID not colliding with the first cell ID out of the cell ID available in the target donor node.

8. The non-transitory computer-readable storage medium according to claim 7, wherein
the cell ID is a physical cell ID (PCI).

9. A chipset for a mobile IAB node movable in a cellular communication system, the chipset comprising:
being configured with a first cell ID which is usable in a movable IAB node from an OAM;
receiving a Handover Command message including an F1 message from a donor node; and
activating a second cell ID including the F1 message, wherein
the second cell ID is a cell ID not colliding with the first cell ID out of the cell ID available in the target donor node.

10. The chipset according to claim 9, wherein
the second cell ID is a cell ID not colliding with the first cell ID out of the cell ID available in the target donor node.
